(19) United States
(12) Patent Application Publication
(10) Pub. No.: US 2007/0278704 A1
(43) Pub. Date: Dec. 6, 2007

(54) Replication of a High-Density Relief Structure

(75) Inventor: Erwin Rinaldo Meinders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,597

(22) PCT Filed: Sep. 2, 2005
(86) PCT No.: PCT/IB05/52880

§ 371 Date: Mar. 2, 2007

(30) Foreign Application Priority Data
Sep. 7, 2004 (EP) 04104304.3

(51) Int. Cl. B29C 33/40; B29C 35/08; B29D 11/00; B29C 67/00

(52) U.S. Cl. 264/2.5; 264/225; 264/496

(57) ABSTRACT

The invention relates to a method for manufacturing a reverse mold (2, 4) for replicating a high-density relief structure (1), to such a reverse mold (2, 4) and to a method for replicating of such a high-density relief structure (1). To provide an improved and reliable method for the best possible replication of a high-density relief structure (1) a method for manufacturing a reverse mold (2, 4) for replicating a high-density relief structure (1) is proposed comprising the steps of: applying a curable polymer to a surface of said high-density relief structure (1) having surface shape information to be replicated, thus forming a layer (2) of curable polymer on said surface of said high-density relief structure (1), curing of said polymer to form a reverse mold (2, 4), and separating said reverse mold (2, 4) from said high-density relief structure (1).

The invention relates to a method for manufacturing a reverse mold for replicating a high-density relief structure, in particular a stamper for fabricating of an optical data carrier. The invention further relates to such a reverse mold and to a method for replicating of such a high-density relief structure.

In conventional mastering of optical data carriers such as ROM discs, as for instance disclosed in EP 1 059 633, a master is produced by a modulated illumination of a thin photo-sensitive layer on a glass substrate. In this layer physical holes are formed so that the now structured surface represents binary data. The structured surface is subsequently covered with a thin Ni layer. In a galvanic process, this sputter-deposited Ni layer is further grown to a thick manageable Ni substrate with the inverse pit structure. This Ni substrate with protruding bumps is separated from the substrate with unexposed areas and is called the father stamper. This father stamper is used for the fabrication of optical discs.

For mass fabrication of optical discs (pre-recorded ROM discs and pre-grooved recordable and rewritable discs), a large number of identical stampers is required to prevent loss of quality due to stamper degradation. In the so-called conventional family process, disclosed, for example, in US 2004/0011762 A2, mother stampers can be galvanically grown from the father stamper. The mother stamper has the inverted polarity compared to the father stamper. Subsequently, a large number of son stampers can be galvanically grown from the mother stampers. The son stampers have the same polarity as the father stampers and are therefore considered as duplicates. The son stampers are used for mass production of ROM discs.

For mastering of high-density optical discs, such as BD-ROM, it is very important that the shortest run lengths are well shaped. This is achieved by using a process that leads to very steep wall angles of the pits. In that case, the shortest run lengths (2T in case of 17PP run length modulation) reach the bottom of the resist layer. This is essential for appropriate readout of the data in the replicated disc. A process that leads to steep walls (70-80°) is based on ultra resist in combination with 10 nm Ni layers in between the resist and substrate. The Ni layer leads to a more uniform absorption profile in the resist layer, and thus to steeper walls.

In particular the steep walls lead to unwanted affects during the passivation step in the conventional family process. During passivation, a thin oxide skin is generated on top of the Ni stamper to facilitate the separation of the father and mother stamper (in case the mother stamper is grown) and mother and son stamper (in case the son is grown) after galvanic growth. It was postulated that the passivation step leads to decomposition of H2O into O2 and H2 gas bubbles. These gas bubbles lead to areas where no Ni is deposited during galvanic growth. These inhomogeneous areas (small defects) lead to unwanted surface roughness and bad replication.

It was found that the discs replicated with the conventionally grown son stampers have a much higher jitter than the disc replicated from the reference father stamper. This degradation in signal quality is particularly due to the surface roughness at bit length level. The 1.5% jitter difference is unacceptable due to the tight jitter margins as prescribed by the BD-ROM standard.

The invention is also very useful in connection with phase transition mastering (PTM). PTM is a relatively new method to make high-density ROM and RE/R stampers for mass-fabrication of optical discs. Phase-transition materials can be transformed from the initial unwritten state to a different state via laser-induced heating. Heating of the recording stack can, for example, cause mixing, melting, amorphisation, phase-separation, decomposition, etc. One of the two phases, the initial or the written state, dissolves faster in acids or alkaline development liquids than the other phase does. In this way, a written data pattern can be transformed to a high-density relief structure with protruding bumps or pits. The patterned substrate can, for example, be used as stamper for the mass-fabrication of high-density optical discs or as stamp for micro-contact printing.

For example, the following material systems have been proposed for phase-transition mastering:

1. Conventional phase-change materials (like SnGeSb (18.3% Sn, 12.6% Ge, 69.2% Sb), InGeSbTe (Sb2Te doped with In and Ge), GeSbTe (Ge2Sb2Te5) (see ID 695717, ID 695252),

2. silicide forming materials, like Cu—Si (see ID 694464),

3. TaMoO, WMoO, material systems,

4. TeOx, material systems,

5. ZnS—SiO2, with or without absorption layers, and

6. organic dyes.

Phase-change materials can be selectively etched. For example, the amorphous phase of SbTe materials etches much faster than the crystalline phase. If amorphous writing in a crystalline back-ground (like conventional phase-change recording) is considered, the amorphous areas are dissolved leading to a pit structure. If crystalline writing in an amorphous background is considered, the initial unwritten material is dissolved such that a bump structure remains.

For Cu—Si, the Cu and Cu—Si is etched much faster than the unwritten Si under layer. A pit structure remains.

For the oxides, TaMoO, WMoO, and TeOx a sort of phase-separation occurs, this means oxidation and reduction of the oxides. The stoichiometric oxides dissolve in alkaline liquids, thereby also dissolving the reduced metal particles. In this way pits are created.

ZnS—SiO2 also exhibits selective etching. The written (heated) phase dissolves much slower in acids than the initial phase does. In that way, a bump structure remains.

Organic dyes can also be thermally heated to obtain a bump structure. Although the recording material is organic, additional inorganic layers may be required to obtain well-defined marks.

We have seen that PTM master substrates at least in most cases contain a recording stack with inorganic materials. Further, both polarities (pits and bumps) can be obtained with PTM.

The illuminated and developed PTM master substrate is the starting point for mass-replication of BD-ROM discs. If the substrate, including the developed recording stack, is rigid enough, it can directly be used for replication. However, the number of shots from such a master substrate may be limited due to wear of the master substrate. It is advantageous to make a stamper from the developed PTM substrate with which the mass-replication (injection molding) is done.

The following problems can occur when stampers are made from developed PTM substrates according to the standard stamper making process:

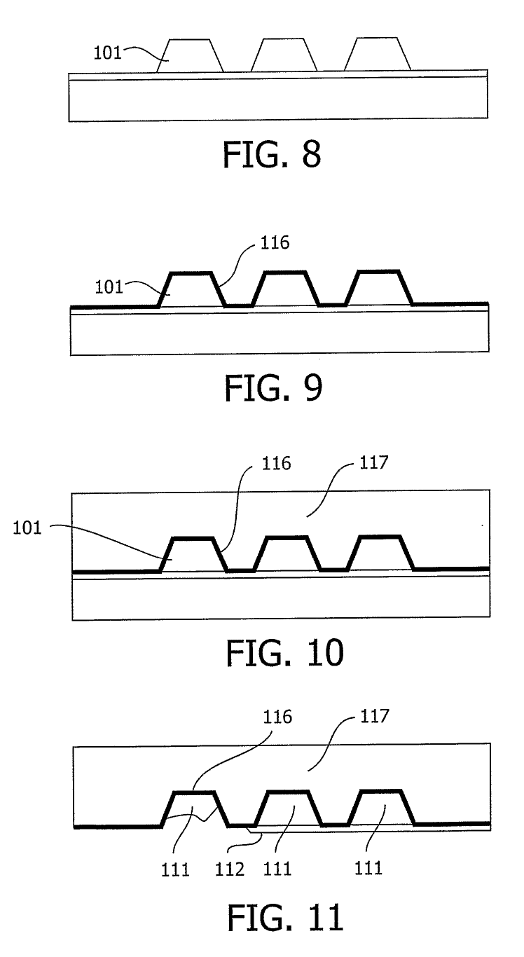

The PTM recording stacks comprise one or more inorganic layers. If a Ni replica (stamper) is made form the developed substrate, the recording stack may partly adhere to the Ni interface. In other words, the separation of the Ni stamper and the developed master substrate fails, which leads to partial contamination and thus deterioration of the data. After application of the default process steps to make a Ni replica of the embossed (illuminated and developed) PTM, the separation of stamper and substrate may be incomplete leading to small-scale residues. These residues deteriorate the data quality. Two types of residues may remain on the stamper surface. Breakup of the protruding bumps of the embossed PTM substrate may occur. Also, separation at the substrate-stack interface may occur. The residues are difficult to remove because cleaning liquids like acids will also deteriorate the Ni stamper. This problem is illustrated in FIGS. 8 to 11, wherein FIG. 8 shows a high density relief structure 101 provided in a PTM master substrate, FIG. 9 shows a Ni layer 116 sputter-deposited on the high density relief structure 101 of FIG. 8, FIG. 10 shows a Ni stamper 117 electro-chemically grown on the Ni layer 116 of FIG. 9, and FIG. 11 shows the Ni stamper 116 of FIG. 10 after a partial separation from the PTM substrate. In FIG. 11 the above mentioned two types of residues are indicated, wherein reference numeral 111 denotes a breakup of a protuding PTM material bump and reference numeral 112 denotes a residue originating from the substrate stack.

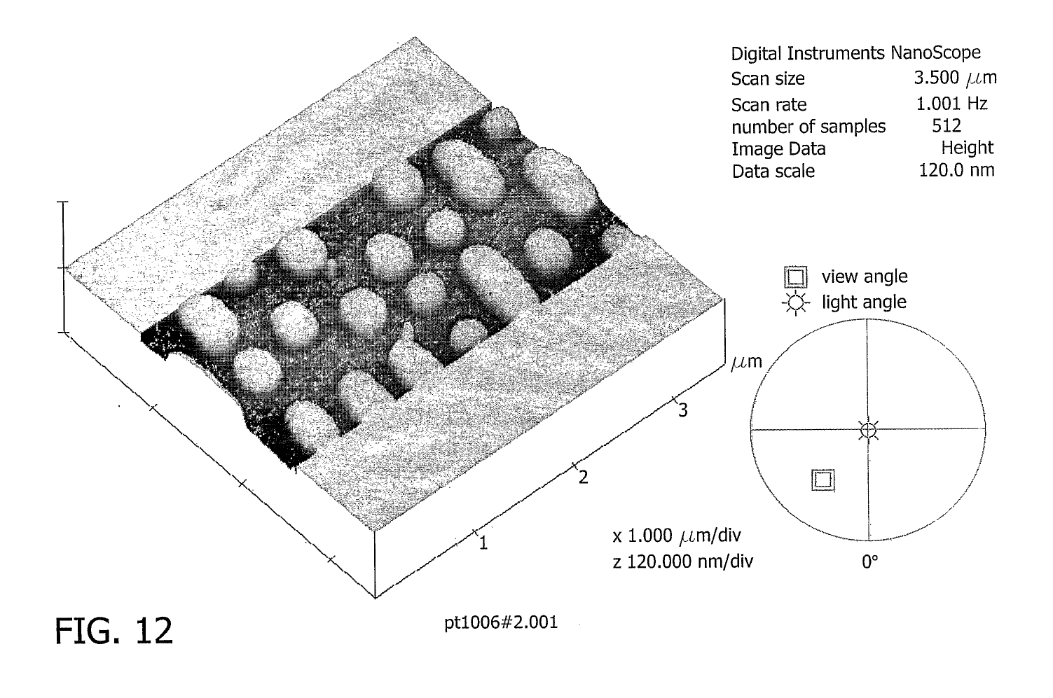

The other problem is that the developed master substrate in many cases has the wrong polarity (bumps instead of pits). This means that the first Ni reverse mold (father stamper) contains pits. Replication in polycarbonate via injection molding has not been proved with this polarity. This means that a replica should be made from the first Ni father, i.e. a mother stamper is needed. This mother stamper contains bumps. Replication with this mother stamper results in substrates with pits. This is again the standard replication process. The father-mother plating process is still not optimum and is accompanied by some deterioration during electrochemical plating. An example of an embossed (illuminated and developed) PTM master substrate is given in FIG. 12 which shows an example of a bump structure in a recording stack that was sputter-deposited on a glass substrate. The recording stack was based on ZnS—SiO2 with SnGeSb absorption layers. The substrate was illuminated with a blue laser beam recorder (NA=0.9, 405 nm wavelength, track-pitch=500 nm) and subsequently developed with 5% HNO3 acid solution to dissolve the initial phase.

It is an object of the invention to provide a reliable method for replicating a high-density relief structure which also overcomes the problem described above. It is a further object of the invention to provide a reliable method for manufacturing a reverse mold for replicating a high-density relief structure as well as to provide such a reverse mold.

In order to achieve the objects a method for manufacturing a reverse mold for replicating a high-density relief structure is proposed comprising the steps of:
applying a curable polymer to a surface of said high-density relief structure having surface shape information to be replicated, thus forming a layer of curable polymer on said surface of said high-density relief structure,
curing of said polymer to form a reverse mold, and
separating said reverse mold from said high-density relief structure.

Further, a method for making a replica of a high-density relief structure is proposed comprising the steps of:
manufacturing a reverse mold according to a method as claimed in claim 1,
forming a replica using said reverse mold, and
separating said replica from said reverse mold.

Thus, a reverse mold for replicating a high-density relief structure comprises a layer of a cured polymer having surface shape information to be transferred to a replica of said high-density relief structure.

A high-density relief structure is a structure with spatial details of a small or very small size, for example details smaller than 100 μm or even smaller than 1 μm.

The invention is based on the insight, that a reverse mold for the purpose of replicating only has to have a surface structure corresponding to the high-density relief structure to be replicated. It further shall be separated rather easily from the original relief structure without damage or change of its surface structure. It does not need to have similar physical, e.g. mechanical, properties as the original relief structure or be provided to fulfill the functions of the original relief structure. In particular, there is no requirement that the reverse mold is made of the same material as the high-density relief structure or its replica. Thus, the material used for the reverse mold may solely selected for its ability to assume a shape corresponding to the relief structure to be replicated.

In an embodiment of a method for manufacturing a reverse mold said high-density relief structure is a father stamper for fabricating an optical data carrier and said surface shape information is to be transferred in reverse form to said optical data carrier. Especially in the field of fabrication of optical data carriers there is a need for a number of replicas of a father stamper as good as possible. The invention allows the manufacturing of a reverse mold of said father stamper and to use said reverse mold to replicate a large number of son stampers while father stamper and reverse mold are kept virtually unchanged, so that the reverse mold and/or the father stamper may be used again at later time.

In a preferred embodiment of a method for manufacturing a reverse mold said curable polymer is a lacquer. Lacquers are known for their advantage that they can easily assume relief structures with even small or very small details.

In a further embodiment of a method for manufacturing a reverse mold said curable polymer is curable by irradiation, in particular by irradiation of light, preferably of ultraviolet light. There are other possibilities for curing said curable polymer as for example by heat or by a chemical reaction induced by adding a starter or by applying heat or irradiation. The curing by irradiation has the advantage that it is possible to select areas where a curing takes place and where not. Further there is the possibility to decide on the exact moment when the curing will be done which provides a better handling for the process of manufacturing said reverse mold.

In a particular embodiment of a method for manufacturing a reverse mold said curable polymer is a hexandioldiacrylat lacquer. It was found that this polymer can be easily released for example from stampers made of nickel which are used in the fabrication of optical data carriers.

In a preferred embodiment of a method for manufacturing a reverse mold there is the further step of attaching a support carrier to a side of said layer opposite of said high-density relief structure. Said support carrier gives said layer an additional mechanical strength so it does better resist, for example the mechanical stress involved in the separating of said reverse mold from said relief structure. Said support carrier may additionally be used for eliminating, for example, gas bubbles in said layer of said curable polymer.

In a particular embodiment of a method for manufacturing a reverse mold said support carrier is substantially transparent, in particular to said irradiation described above, in particular that said support carrier is made of glass, quartz, polycarbonate or polymethyl methacrylate. If said support carrier is transparent, particularly to the irradiation used for curing, said irradiation may be easily applied to said curable polymer right through said support carrier. If said support carrier is transparent in general, the layer of curable polymer can be checked for example for gas bubbles before curing, so that measurements can be done to eliminate said gas bubbles if necessary.

In an embodiment of a method for making a replica, in particular a stamper for fabricating an optical data carrier, said replica is formed by depositing a metal layer on a side having said surface shape information of said reverse mold. Normally metal stampers are used for fabricating of optical data carriers.

In a preferred embodiment of a method for making a replica the step of depositing comprises the steps of:
forming of a metal coating on said reverse mold, in particular by sputtering, and
growing of said metal coating to form said metal layer, in particular by galvanical growing.

The step of forming said coating, for example by sputtering, provides that said metal coating assumes the shape to be replicated as good as possible while being rather slow. The growing, for example galvanical growing, of said metal coating is much faster than the sputtering. Thus, a combination of these two steps provides a best possible replication combined with sufficiently fast processing.

In a further embodiment of a method for making a stamper said metal is nickel. Is was found that nickel is a good choice for a material of a stamper used for fabricating an optical data carrier and that nickel can be easily separated from a polymer layer, in particular from a layer made of hexandioldiacrylat lacquer.

In a further preferred embodiment of a method for manufacturing a reverse mold said high-density relief structure is provided by phase transition mastering. In some cases the reverse mold can be directly used, for example, as a stamper for transferring data to an optical disc, or as a stamp for micro contact printing. However, it is also possible to use the reverse mold for making a replica of the original high density relief structure, for example to make a Ni stamper.

Particularly if the high density relief structure is provided in a phase transition material by PTM, it is preferred that said reverse mold is rinsed with a cleaning liquid after separation from said high-density relief structure. Such a cleaning process can be necessary if the reverse mold can not be separated from the original high density relief structure without residues remaining in the reverse mold. Such residues can be completely removed from the reverse mold by rinsing it with a cleaning liquid, for example with an acid.

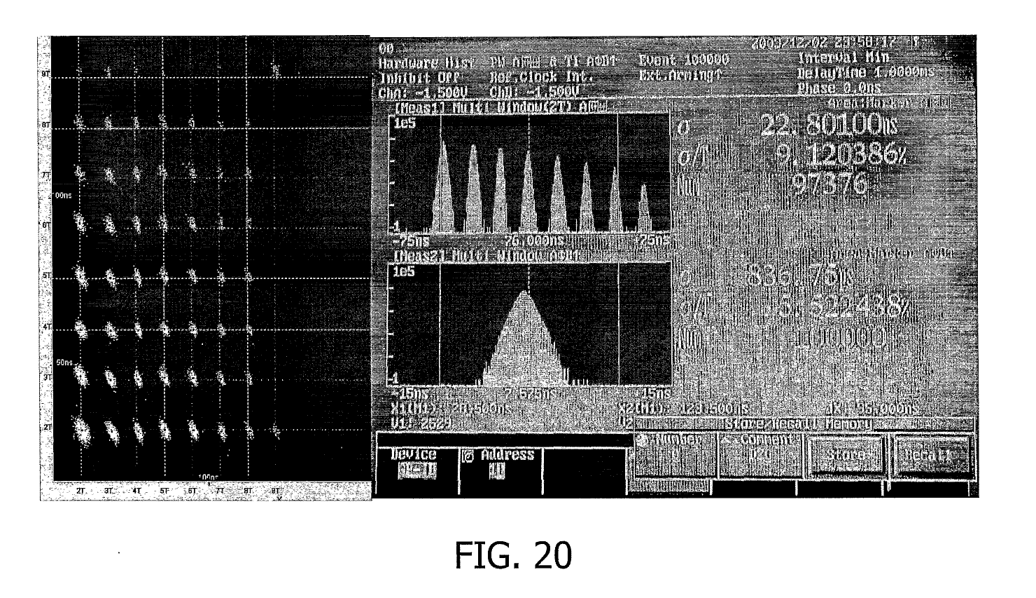

In the following, embodiments of methods for manufacturing reverse molds and of methods for making a replicas according to the present invention will be explained further in detail with reference to the figures, all except FIGS. 12 and 20 showing cross sectional views, in which:

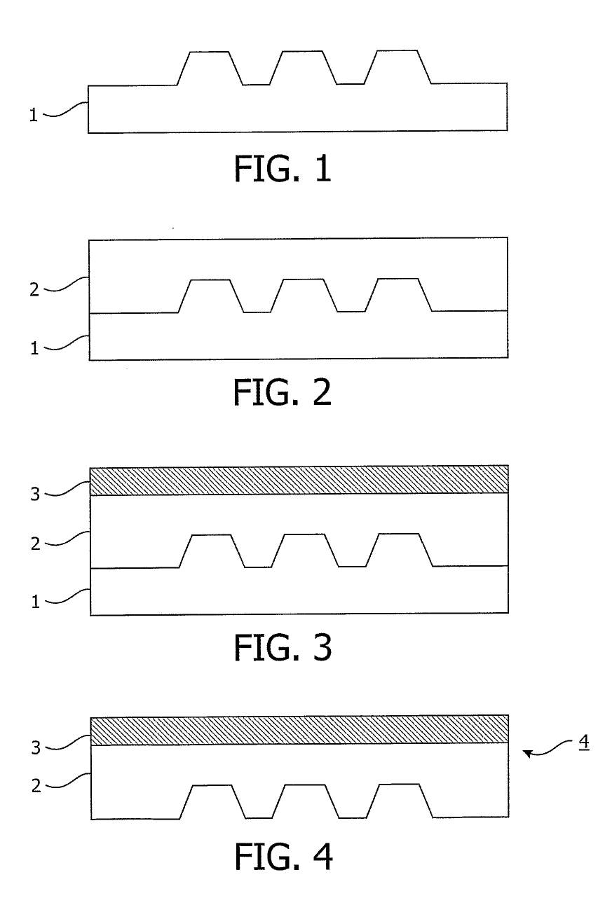

FIG. 1 shows a relief structure,

FIG. 2 shows the relief structure of FIG. 1 with a layer of curable polymer,

FIG. 3 shows the relief structure with the layer of curable polymer of FIG. 2 and an attached support carrier,

FIG. 4 shows a reverse mold formed by curing said polymer,

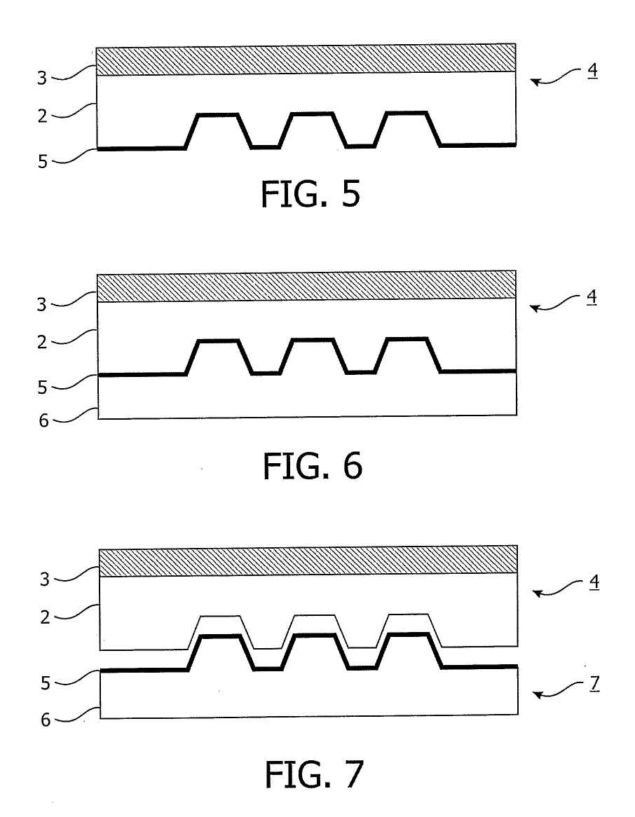

FIG. 5 shows the reverse mold of FIG. 4 with a coating,

FIG. 6 shows the reverse mold of FIG. 4 with a replica of the relief structure of FIG. 1,

FIG. 7 shows the replica separated form the reverse mold of FIG. 6,

FIG. 8 shows a high density relief structure provided in a PTM master substrate,

FIG. 9 shows a Ni layer sputter-deposited on the high density reliev structure of FIG. 8,

FIG. 10 shows a Ni stamper electro-chemically grown on the Ni layer of FIG. 9,

FIG. 11 shows the Ni stamper of FIG. 10 after a partial separation from the PTM substrate,

FIG. 12 shows an example of a bump structure created in a PTM material,

FIG. 13 shows a high density relief structure provided in a PTM master substrate,

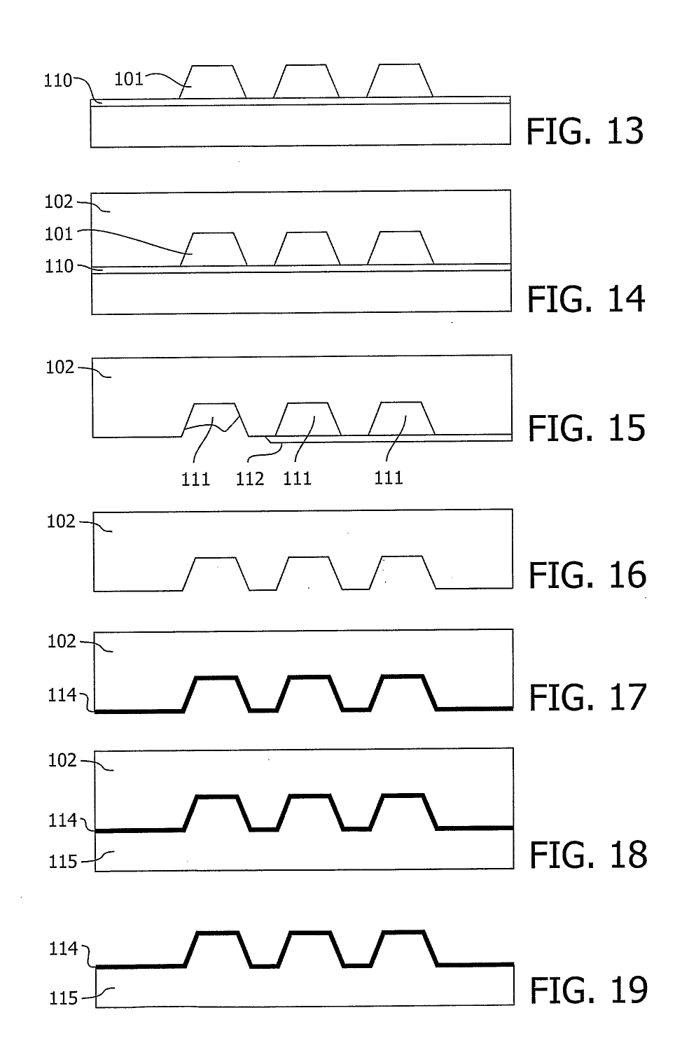

FIG. 14 shows a 2P father reverse mold made on the basis of the high density relief structure of FIG. 13,

FIG. 15 shows the 2P father reverse mold of FIG. 14 after a (partial) separation from the PTM master substrate,

FIG. 16 shows the 2P father reverse mold of FIG. 15 after cleaning,

FIG. 17 shows the 2P father reverse mold of FIG. 16 comprising a sputter-deposited Ni layer,

FIG. 18 shows a Ni mother stamper electro-chemically grown on the Ni layer of FIG. 17,

FIG. 19 shows the Ni mother stamper of FIG. 18 separated from the 2P father reverse mold, and

FIG. 20 shows a jitter measurement on a disc made on the basis of a mother stamper produced in accordance with the method illustrated in FIGS. 13 to 19.

FIG. 1 shows a relief structure 1, such as a stamper for fabricating an optical data carrier. The surface of the relief structure 1 has a distinct spatial shape which is to be replicated. On said surface of said relief structure 1 a layer 2 of curable polymer is applied as shown in FIG. 2. For a better handling and a better mechanical strength of the reverse mold to be formed a support carrier 3 is attached to a side of said layer 2 opposite of the relief structure, which is illustrated in FIG. 3. The polymer is cured and the thus formed reverse mold 4 is separated form said relief structure 1 as shown in FIG. 4. For the replicating of said relief structure 1 a coating 5 is formed on said reverse mold 4 on the surface which was formerly in contact with said relief structure 1 as shown in FIG. 5. A suitable method for forming such coating is for example sputtering of a metal like nickel. As indicated by FIG. 6 on said coating a metal layer 6 is grown to form a replica of said relief structure 1. As illustrated in FIG. 7 said replica 7 comprising said coating 5 and said metal layer 6 is separated from said reverse mold 4, which can be used for making another replica.

There are virtually only two limits for relief structures 1 which can be replicated according to the present invention. The density of the relief 1 must not be so high or its structure details must not be so small that there would no possibility to replicate the surface structure by any curable polymer. The second limit is that it is in general not possible to replicate structures 1 with projections which hinder the revere mold 4 from being separated form the relief structure 1.

The invention is not limited to polymers curable by irradiation since there are several other possibilities for curing a polymer such as curing by heat or due to a chemical reaction which may be induced by adding a starter or applying heat or irradiation. It may also be possible to use a self-curing polymer if the process of applying the polymer can be completed before the curing is completed. There should be no substantial change of shape or size during curing since this may harm the relief structure 1, the polymer layer 2 or both. Some change may be compensated by heating or cooling the relief structure 1 thus utilizing its thermal expansion or shrink.

The thickness of the polymer layer 2 which is applied to the relief structure 1 should be large enough to cover the complete relief structure 1. When a support carrier 3 is used, the thickness may be relatively small, such as 0.2 mm or less, since sufficient mechanical strength is given to the reverse mold 4 by the support carrier 3. It was found during experiments that a thickness between 10 and 100 μm was suitable for a stamper 1 with a pit depth of 100 nm. Nevertheless, the layer 2 may also have such a thickness that it can be handled without the need for an additional support carrier 3, for example 10 mm or more.

In the following the invention is further described with reference to findings and results of a particular application of the present invention, namely the replication of stampers for fabricating an optical data carrier.

The replicated and UV-cured photo-sensitive lacquer 2, in particular HDDA (=hexandioldiacrylate) can easily be released from the father stamper 1 made of nickel (Ni). This was found from the comparison of data that is measured on the father stamper 1 and on the reverse mold 2, 4.

A reverse mold 2, 4 is made from the Ni father stamper (FIGS. 1-4). This reverse mold 2, 4 is provided with a sputter-deposited Ni layer 5 (FIG. 5). During experiments the Ni layer had a thickness of about 100 nm. This reverse mold 2, 4 with thin Ni layer 5 is subsequently subjected to a galvanical growing to produce a replica 7 or son stamper (FIGS. 6, 7). The advantage of this replication process is the avoidance of Ni—Ni contacts, and thus the avoidance of the passivation step to generate thin oxide layers to facilitate the separation. It was found that the replication is very good, the surface roughness is low and defect generation seems to be suppressed. The replica 7 could have been formed only by sputtering or an equivalent method even though it would have take much longer to form the complete son stamper 7. Another material could also be used for forming the replica. It is easier to find a suitable polymer if the original relief structure 1 and the replica 7 are made of the same material or at least of corresponding materials since the reverse mold 4 shall be separated from both, the relief structure 1 and the replica 7, without damaging either of them.

The Ni son stamper 7 was used for the fabrication of test discs. These discs were provided with a 15 nm Aluminum layer and bonded with a 100 mm cover layer. A detailed analysis of the fabricated disc was carried out. It was found that the variations in run length are limited and that the different run lengths are clearly separated. The measured limit equalizer jitter was 5.5% (5.1 dB, number of samples=100.000) at an asymmetry of 14.8%. This value is similar to the values measured at discs fabricated from the father stamper 1. It is therefore concluded that there is no loss of signal quality due to the replication step according to the present invention.

FIGS. 13 to 19 illustrate the making of a replica in form of a Ni stamper on the basis of a high density relief structure provided in a PTM material. FIG. 13 shows a high density relief structure 101 provided in a phase transition material layer. The phase transition material is arranged over an absorption layer 110 which is carried by a substrate 113. FIG. 14 shows a 2P father reverse mold 102 made on the basis of the high density relief structure 101 of FIG. 13. To make the 2P father reverse mold 102, a soft replication step in 2P lacquer (HDDA=hexandioldiacrylate) is used. This 2P lacquer is UV-cured to make it rigid. The resulting 2P father reverse mold 102 is inert to acids and alkaline liquids. FIG. 15 shows the 2P father reverse mold 102 of FIG. 14 after a separation from the PTM master substrate. As may be seen, residues 111, 112 adhere to the 2P father reverse mold 102, wherein the residues 111 originate from broken bumps of the high density relief structure 101 and the residue 112 originates from the absorption layer 110. FIG. 16 shows the 2P father reverse mold 102 of FIG. 15 after cleaning with a cleaning liquid, for example with an acid or alkaline liquid. As mentioned above, such a cleaning is possible since the UV-cured 2P father reverse mold 102 is resistant to cleaning liquids like acids that dissolve the residues 111, 112, but will not deteriorate the 2P father reverse mold 102. FIG. 17 shows the 2P father reverse mold 102 of FIG. 16 comprising a sputter-deposited Ni layer 114. FIG. 18 shows a Ni mother stamper 115 electro-chemically grown on the Ni layer 114 of FIG. 17, and FIG. 19 shows the Ni mother stamper 115 of FIG. 18 separated from the 2P father reverse mold 102. For Example, optical discs replicated with such a 2P replica based mother stamper 115 proved to provide excellent data quality.

FIG. 20 shows a jitter measurement on a disc made on the basis of a mother stamper produced in accordance with the method illustrated in FIGS. 13 to 19. Shown are a clouds plot (inter symbol interference diagram) on the left side of FIG. 20 and a histogram of the different run lengths in the 17PP code for a BD-ROM disc (track pitch 320 nm, channel bit length 74.5 nm) on the right side of FIG. 20. It can be seen that the variation in run length is limited and that the different run lengths are clearly separated. The measured limit equalizer jitter is 5.5% (5.1 dB, number of samples=100.000) at an asymmetry of 14.8%. This value is similar to the values measured at discs replicated from a reference father stamper.

An additional advantage of the soft replica step is the inversion of polarity. For some of the most promising material systems, the developed master contains bumps rather than pits. The inverse mold, a father will have a pit structure. The replica, a mother, contains again the preferred bumps for BD-ROM replication. In accordance with the invention the reverse mold can be the 2P reverse mold, this means an extra Ni stamper is not required.

The polarity reversal properties make the invention also very useful for photoresist mastering with image reversal photoresists. In such case, the illuminated areas remain as bumps at the surface, the unexposed area is completely washed away during development. A soft 2P father replica is proposed to end up with a mother Ni stamper with protruding bumps.

The present invention proposes an improved and reliable method for the best possible replication of a high-density relief structure and a corresponding method for manufacturing a reverse mold to be used in the above method.

The invention is not limited to the replication of stampers used for a fabrication of optical data carriers. It may also be implemented in other fields where high-density relief structures, i.e. spatial structures with small or very small details, are to be replicated or used as for example in micro-contact printing for printing of micro-structures, for example for structures for displays, biosensors, etc.

1-14. (canceled)

15. Method for manufacturing a reverse mold (2, 4; 102) for replicating a high-density relief structure (1; 101) comprising the steps of:
applying a curable polymer to a surface of said high-density relief structure (1; 101) having surface shape information to be replicated, thus forming a layer (2; 102) of curable polymer on said surface of said high-density relief structure (1; 101),
curing of said polymer to form a reverse mold (2, 4; 102), and
separating said reverse mold (2, 4; 102) from said high-density relief structure (1; 101)
characterized in that said high-density relief structure (101) is provided by phase transition mastering, wherein said reverse mold is rinsed with a cleaning liquid after separation from said high-density relief structure (101).

16. Method for manufacturing a reverse mold (2, 4; 102) as claimed in claim 1, wherein said high-density relief structure (1; 101) is a father stamper for fabricating an optical data carrier and said surface shape information is to be transferred in reverse form to said optical data carrier.

17. Method for manufacturing a reverse mold (2, 4; 102) as claimed in claim 1, characterized in that said curable polymer is a lacquer.

18. Method for manufacturing a reverse mold (2, 4; 102) as claimed in claim 1, characterized in that said curable polymer is curable by irradiation, in particular by irradiation of light, preferably of ultraviolet light.

19. Method for manufacturing a reverse mold (2, 4; 102) as claimed in claim 4, characterized in that said curable polymer is a hexandioldiacrylat lacquer.

20. Method for manufacturing a reverse mold (2, 4) as claimed in claim 1, further comprising the step of attaching a support carrier (3) to a side of said layer (2) opposite of said high-density relief structure (1).

21. Method for manufacturing a reverse mold (2, 4) as claimed in claim 6, characterized in that said support carrier (3) is substantially transparent, in particular to said irradiation claimed in claim 4, in particular that said support carrier (3) is made of glass, quartz, polycarbonate or polymethyl methacrylate.

22. Reverse mold (2, 4; 102) in particular manufactured according to a method as claimed in claim 1 for replicating a high-density relief structure (1; 101), characterized in that said reverse mold (2, 4; 102) comprises a layer (2; 102) of a cured polymer having surface shape information to be transferred to a replica (7; 115) of said high-density relief structure (1; 101).

23. Method for making a replica (7; 115) of a high-density relief structure comprising the steps of:
manufacturing a reverse mold (2, 4; 102) according to a method as claimed in claim 1,
forming a replica (7; 115) using said reverse mold (2, 4; 102), and
separating said replica (7; 115) from said reverse mold (2, 4; 102).

24. Method for making a replica (7; 115), in particular a stamper (115) for fabricating an optical data carrier, as claimed in claim 9, wherein said replica (7; 115) is formed by depositing a metal layer (5, 6; 114) on a side having said surface shape information of said reverse mold.

25. Method for making a replica (7; 115) as claimed in claim 10, wherein the step of depositing comprises the steps of:
forming of a metal coating (5; 114) on said reverse mold, in particular by sputtering, and
growing of said metal coating (5; 114) to form said metal layer (5, 6; 115), in particular by galvanical growing.

26. Method for making a stamper as claimed in claim 10, characterized in that said metal is nickel.
